(19) United States
(12) Patent Application Publication
(10) Pub. No.: US 2002/0170325 A1
(43) Pub. Date: Nov. 21, 2002

(54) Door unlocking system for vehicle

(76) Inventor: Jae Hong Choi, Gwangmyeong-si (KR)

Correspondence Address: CHRISTIE, PARKER & HALE, LLP, 350 WEST COLORADO BOULEVARD, SUITE 500, PASADENA, CA, 91105, US

(21) Appl. No.: 09/977,891

(22) Filed: Oct. 11, 2001

(30) Foreign Application Priority Data
May 16, 2001 (KR) 2001-26760

(51) Int. Cl. E05B 53/00

(52) U.S. Cl. 70/264

(57) ABSTRACT

The invention provides a door unlocking system with the switch transmitting the signal to the central processing unit (10) according to the rotary direction of the key inserted into the key box to unlock the front and rear doors, wherein the switch is installed at the door latch (30) unlocking the driver door and the switch transmits the signal to the central processing unit according to the signal input in the key rod clip (31) to unlock the other doors, in the inserted status, the key turns to one direction to operate the switch, thereby installing the switch in the driver door regardless of the door chassis and the key rotor.

### BACKGROUND OF THE INVENTION

1. Field of the Invention

This invention relates to a door unlocking system of vehicles, and more particularly, to the door unlocking system in which a switch for simultaneously unlocking the front and rear doors is installed regardless of a door chassis and a key rotor.

2. Description of the Prior Art

Generally, the driver s door includes a switch for transmitting a signal to a central processing unit, wherein the driver inserts the key into the key box and turns the key to one direction to simultaneously unlock the front door and rear door while the driver turns the key inserted in the key box to the other direction to simultaneously lock the front door and rear door.

The prior art (FIG. 1) shows installation of a switch 10 rearward of the key box 20, which is disadvantageous in that the narrow space between a door chassis and a key rotor does not allow the switch 10 to be installed rearward the key box 20.

### SUMMARY OF THE INVENTION

Accordingly, it is an object of the present invention to provide a door unlocking system for unlocking the front and rear doors by outputting to the central processing unit from the switch in the directions from the neutral position of the key inserted into the key box, in which the switch is installed at the door latch for unlocking the driver s door, and the switch transmits the signal to the central processing unit according to the signal input in the key rod clip to unlock the other doors. The key rod clip and the switch are connected by a key rod link, link and a switch link. The key rod link is connected to the key rod clip at one end, the link is connected to the key rod link at the other end, and switch link is connected to the link 34 and the switch, respectively.

### BRIEF DESCRIPTION OF THE DRAWINGS

The present invention will become more fully understood from the detailed description given hereinbelow and the accompanying drawings, which are given by way of illustration only, and thus, are not limitative of the present invention, and wherein:

FIG. 1 is a sectional view showing the installation of the conventional switch; and

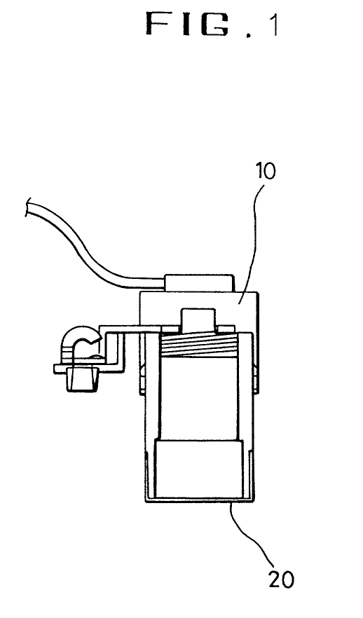

FIG. 2 is a sectional view showing the installation according to the present invention.

### DESCRIPTION OF THE PREFERRED EMBODIMENTS

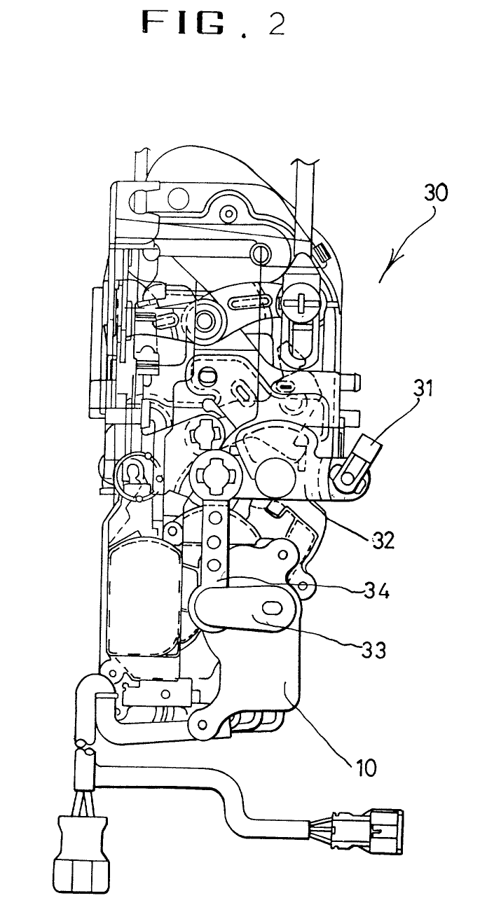

As shown in FIG. 2, the door unlocking system of the present invention adopts the conventional switch 10 transmitting the signal to the central processing unit, dependent on the activating direction of the ignition key inserted in the key box, to unlock the front and rear doors.

In the present invention, however, the switch 10 is installed at the door latch 30 for unlocking the driver s seat door and transmits the signal to the central processing unit according to the signal input in the key rod clip 31, to unlock the other doors.

The key rod clip 31 and the switch 10 are connected by a key rod link 32, link 34 and a switch link 33. The key rod link 32 is connected to the key rod clip 31 at one end, the link 34 is connected to the key rod link 32 at the other end, and switch link 33 is connected to the link 34 and the switch 10, respectively.

According to the present invention, when the driver in a car inserts the key into the key box and turns the key in one direction, the rotation force of the key is transmitted as a rectilinear movement to the key rod clip 31. The rotation force of the key transmitted to the key rod clip 31 causes the key rod link 32 to rotate and thus cause rectilinear movement of link 34. The actuating force of the key rod link is transmitted as a rotating force to the switch link 33 via the link 34.

After the switch link 33 receives the rotation force from the key, the switch 10 transmits the signal to the central processing unit to unlock the front door and the rear door as well as the driver's door. Switch link 33 is made to turn the contact of the switch ON/OFF, and as a result, movement, in different degrees of the switch link to the switch. This, in turn, causes the switch, depending on the degrees of the rotation of the key to provide different signals to the processing unit, which in turn either opens the driver's door alone or all doors of the vehicle. Thus first degrees of rotation cause a first signal to the processing unit which sends a first signal to open only the driver's door and second degrees of rotation cause a second signal to the processing unit which sends a second signal to open all doors of the vehicle.

Accordingly, the switch 10 is fixed at the door latch 30 and connected to the key rod link 32, link 34 and switch link 33, so that the switch 10 can be installed separate from the key box.

The present invention is not limited to these embodiments, and it should be clear to those skilled in the art that other embodiments are possible within the spirit and scope of the invention claimed.

What is claimed is:

1. A door unlocking system for a vehicle for unlocking doors of the vehicle responsive to a central processing unit outputting a signal indicating a direction of movement of a switch in a key box of the vehicle in different degrees of rotation of the key in the key box, the system comprising:
a switch installed in a door latch for unlocking the driver's door of the vehicle; and
a key rod clip connected for providing to the switch an input movement corresponding to a movement of the key; and
the switch thereby transmitting a signal to such central processing unit according to the input movement provided by the key rod clip to thereby unlock the doors.

2. The door unlocking system for a vehicle as claimed in claim 1, characterized in that the key rod clip 31 and the switch 10 are connected by a key rod link 32, a link 34, and a switch link 33, whereby the key rod link is connected at one end thereof to the rod clip, the link 34 is connected to another end of the key rod link, and the switch link is connected between the link 34 and the switch.
